(19) United States
(12) Patent Application Publication
(10) Pub. No.: US 2024/0212570 A1
(43) Pub. Date: Jun. 27, 2024

(54) Electronic Devices and Corresponding Methods for Delivering an Extended Display Identification (EDID) Extension Identifying a Connected Input Source

(71) Applicant: Motorola Mobility LLC, Chicago, IL (US)

(72) Inventors: Amit Kumar Agrawal, Bangalore (IN); Yuliang Wang, Xiamen (CN); Gautham Natakala Prabhakar, Bangalore (IN)

(21) Appl. No.: 18/113,990

(22) Filed: Feb. 24, 2023

(30) Foreign Application Priority Data
Dec. 22, 2022 (CN) 202211654377.X

(51) Int. Cl. G09G 3/20; G06F 13/40

(52) U.S. Cl. CPC G09G 3/2096; G06F 13/4081; G09G 2370/042; G09G 2370/12; G09G 2370/20; G09G 2370/22

(57) ABSTRACT

An electronic device includes a communication device and one or more processors operable with the communication device. The one or more processors, in response to the communication device identifying a port establishing a display data channel, causing the communication device to transmit an extended display identification (EDID) extension or second-generation EDID file structure comprising an identity of the port using the display data channel.

### BACKGROUND

### Technical Field

This disclosure relates generally to electronic devices having communication circuits, and more particularly to electronic devices engaged in the transmission of signals supplied in digital form, including data transmission and telegraphic communication, with an image display device.

### Background Art

Many image display devices use an extended display identification (EDID) data communication protocol to transfer information regarding the capabilities of the device. Illustrating by example, when a display device having EDID capabilities powers up while coupled to a source device operable to deliver content to the display device, the display device may transmit an EDID file structure that exposes information about the display device to inform the source device as to the operating capabilities the display device possesses. While this transfer works well in practice, as more complex display devices are developed the problem of ensuring proper EDID information becomes more critical. It would be advantageous to have improved electronic devices and corresponding methods that assist in this respect.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory image display device in accordance with one or more embodiments of the disclosure.

FIG. 2A illustrates a portion one explanatory hot plug detection circuit in accordance with one or more embodiments of the disclosure.

FIG. 2B illustrates another portion of one explanatory hot plug detection circuit in accordance with one or more embodiments of the disclosure.

FIG. 3 illustrates one explanatory method in accordance with one or more embodiments of the disclosure.

FIG. 4 illustrates a prior art EDID file.

FIG. 5 illustrates one explanatory EDID extension in accordance with one or more embodiments of the disclosure.

FIG. 6 illustrates another explanatory method in accordance with one or more embodiments of the disclosure.

FIG. 7 illustrates various embodiments of the disclosure.

FIG. 8 illustrates a prior art image display device.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to determining, in an image display device, to which input source of a plurality sources a source device is connected, and thereafter transmitting an EDID extension comprising an identity of the input source to the source device. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of detecting a source device establishing a display data channel with one port of a plurality of ports of an image display device and transmitting an EDID extension identifying the port to the source device using display data channel as described herein. The non-processor circuits may include, but are not limited to, a radio receiver, a radio transmitter, signal drivers, clock circuits, power source circuits, and user input devices.

As such, these functions may be interpreted as steps of a method to perform identifying a port establishing a display data channel to a source device and causing a communication device of an electronic device to transmit an EDID extension comprising the identity of the port using the display data channel. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that image display devices, examples of which include televisions and computer monitors, can be coupled to a wide range of source devices, examples of which include computers, smartphones, tablet computers, set-top boxes, gaming devices, and multimedia players. When such a source device is connected to an image display device, the source device provides images and sounds signals to the image display device. The image display device, in turn, then delivers images and sounds to an environment of the system defined by the source device, the image display device, and the display data channel coupling the two together.

Indeed, many modern electronic devices are equipped with a content redirection feature. Using smartphones manufactured by Motorola Mobility.sup.™ as one illustrative example, some models are equipped with their Ready For.sup.™, which is a feature that allows the Ready For.sup.™ device to act as a source device and connect to an image display device such as a larger monitor, television, or other device having a larger screen. Using the Ready For.sup.™ feature, users can stream video content to the larger display of the image display device with no loss in performance. Illustrating by example, resolution of the images on the image display device is up to 4K with a frame rate that presents content without flicker or distortion.

While the Ready For.sup.™ feature does not require a cable or a docking station, many electronic devices do require a physical connection in the form of a display data channel between the source device and the image display device for a content redirection feature to work properly. To wit, many standards such as the highly popular and ubiquitous high-definition multimedia interface (HDMI) interface standard require a physical wire be connected between a source device and a display device for content redirection to work. Additionally, even some users of advanced content redirection technologies such as Ready For.sup.™ even prefer to use a docking station and/or physical cable to couple their electronic device to an image display device because a physical cable defining a display data channel invariably offers a more reliable and faster data connection than do most wireless connections.

Sometimes, however, connecting a physical cable to an image display device can be a complete nightmare. To illustrate, with many image display devices the rear side includes many ports to which a cable or other physical connector can be coupled to establish a display data channel between the image display device and a source device. Frequently, these ports are located on the rear side of the image display device and are clustered together along a thin strip of the device housing. While offering many different connection modes, e.g., HDMI, coaxial cable, ¼-inch, RCA, optical, universal serial bus (USB), and others, the inputs are frequently closely packed together. Complicating matters, the image display device may include two, three, or four of the same type of inputs such that four different HDMI connections and three different USB connections, for example, can be made to the image display device.

When a person has four such HDMI connections to the image display device, after connecting a source device to one of these connections they frequently have to then “tune” the image display device to the proper input corresponding to the port facilitating the display data channel. They may, for example, be required to use a remote control or other controls on the image display device to cause the processors of the image display device to choose “HDMI3” as the input rather than “HDMI2,” and so forth.

When the image display device is mounted on a wall, the problem can be exacerbated due to the small space between the wall and image display device that a cable or other physical connection must pass. To be sure, it can be difficult to reach a hand and cable between the image display device and the wall to make the proper connection. Even when this can be done, it is frequently almost impossible to visually see which input is which. Monikers identifying the inputs are generally molded into the thin strip of the device housing of the image display device and are therefore the same color as the device housing itself. Even with a flashlight it can be nearly impossible to tell, for example, whether a smartphone is connected to “HDMI1,” “HDMI2,” “HDMI3,” “HDMI4” and so forth.

Even if one knows to which connector their device is connected, they still likely have to find a remote or other device to tune the image display device to that input. This is problematic because different image display devices frequently name their inputs differently. Illustrating by example, while one image display device may call the four HDMI inputs “HDMI1,” “HDMI2,” and so forth, another might label these inputs “Digital1,” “Digital2,” and so forth. Consequently, to find the input source to which the smartphone is connected a user may need to try several different options with the remote control before finally selecting the proper input.

Embodiments of the present disclosure provide solutions to this problem. In one or more embodiments, a method in an image display device comprises detecting, with a communication device, a source device establishing a display data channel with one port of a plurality of ports of the image display device. In one or more embodiments, one or more processors then identify the port. In one or more embodiments, this can be done using a hot plug detection operation using the HDMI or another similar standard (examples of which include DisplayPort.sup.™, or digital video interface (DVI) port standards and protocols).

In one or more embodiments, the one or more processors then write the identity of the port to an EDID extension. The one or more processors then cause the communication device to transmit the EDID extension having the identity of the port to the source device using the display data channel in response to the communication device detecting the establishment of the display data channel.

Embodiments of the disclosure therefore provide a solution enabler that surfaces the input source identified by the image display device to the source device by delivering an EDID extension to the source device using the display data channel that is established by the physical connection between the source device and the image display device. The source device can then easily access this information and present the same to a user, thereby allowing the user to quickly and easily tune the image display device to the proper source or input port without having to manually look at the physical connection at the image display device. Embodiments of the disclosure therefore enhance the EDID standard by including an EDID extension that identifies an input port to which a source device is connected.

Accordingly, in one or more embodiments an image display device that is connectable to a source device comprises a plurality of input source connections and a communication device operable with the plurality of input source connections. In one or more embodiments, the image display device comprises one or more processors operable with the communication device. In one or more embodiments, the one or more processors, in response to the communication device detecting establishment of a display data channel with the source device, determine to which input source the of the plurality of input sources the display data channel is connected. The one or more processors then create an EDID extension comprising an identity of the input source to which the display data channel is connected and cause eh communication device to transmit the EDID extension to the source device using the display data channel.

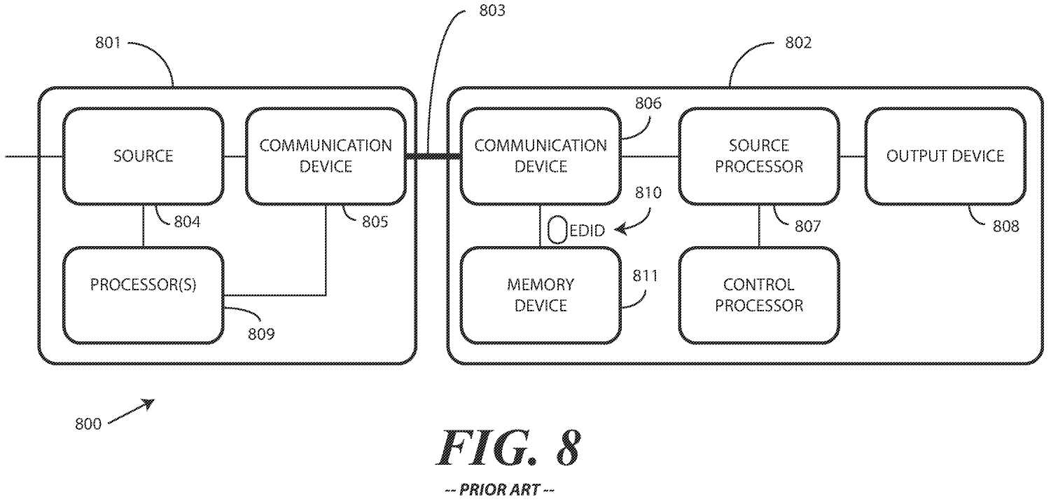

By way of background, and turning now to FIG. 8, illustrated therein is one prior art image display system 800 that includes a source device 801 coupled to an image display device 802 via a display data channel 803. To provide images and sounds to the environment around the image display device system 800, a content source 804 of the source device 801 delivers content (which could be streamed, stored locally, created, or otherwise obtained) to the image display device 802 through a communication device 805.

The image display device 802 then receives that content via its own communication device 806. The image display device 802 then employs a source processor 807 and an output device 808, examples of which include a display and loudspeakers, to deliver the content to the environment.

If the source device 801 and the image display device 802 are coupled together by a physical cable that establishes the display data channel 803, one or more processors 809 of the source device 801 need to determine what output signals are optimized for the content to be presented on the image display device 802. The source device 801 can do this because the image display device 802 sends an EDID file structure 810 stored in a memory device 811 of the image display device 802. An EDID file structure 810 is a standardized communication protocol that allows an image display device 802 to inform the source device 801 regarding the operating capabilities it possesses. Using the EDID file structure 810, the image display device 802 can inform the source device 801 regarding operating characteristics such as native resolution, display size, aspect ratio, color definition, and other supported features. The EDID file structure 810 can even identify the manufacturer and serial number of the content presentation companion device.

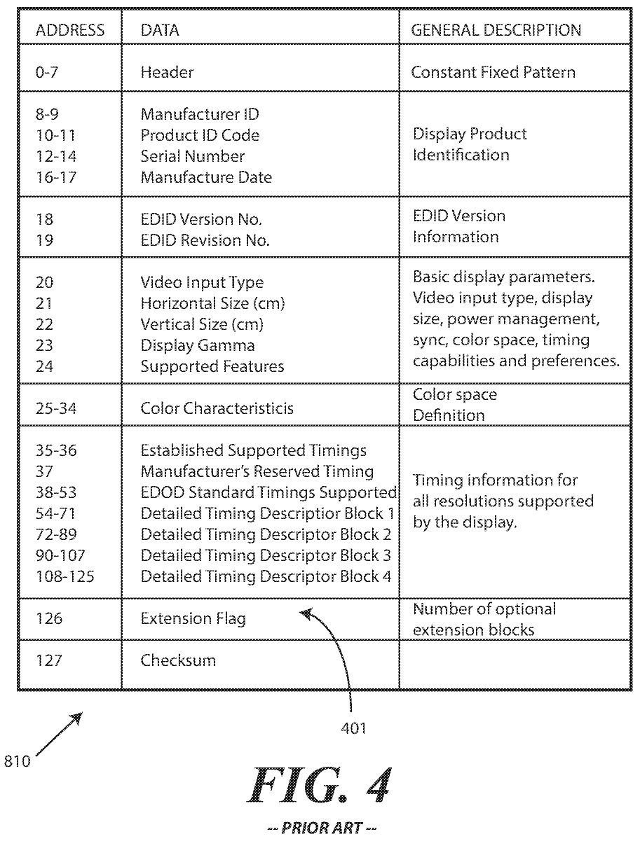

Turning briefly to FIG. 4, illustrated therein is one example of an EDID file structure 810. Communication of the EDID file structure 810 allows a source device to configure the content it delivers to and image display device without the user having to manually configure the same. Additionally, the EDID file structure 810 reduces the chance for the content being transmitted incorrectly from the source device to the image display device. Developed by the Video Electronic Standards Association (VESA), the EDID file structure 810 allows for far more information to be delivered from an image display device to a source device than, for example, having dedicated pins attempt to carry information using binary signals. In one or more embodiments.

The EDID file structure 810 defines a 128-byte data structure that includes manufacturer and operation-related data. As shown in FIG. 4, this information includes a vendor/product identification block, an EDID structure version and revision, basic display parameters and features, color characteristics, established timings, standard timing information, and detailed timing descriptions.

While originally 128 bytes, as image display devices became more advanced the EDID file structure 810 was extended so that additional data could be transmitted. Illustrating by example, in December of 2007 the VESA released a second generation of the EDID file structure. This second generation of the EDID file structure allows for the file structure to be of a variable length that can extend up to 256 bytes. However, the base EDID information is carried in the original EDID file structure 810 that is 128 bytes in length. Legacy image display devices cannot use the second generation of the EDID file structure because it is not backwards compatible with the original EDID file structure.

Relevant to embodiments of the present disclosure, the EDID file structure 810 also allows for an extension flag 401. The extension flag 401, when set, indicates that an extension, which is an additional 128-byte block of data, will be included with the EDID file structure 810 to describe increased capabilities. Such an EDID extension is used in accordance with one or more embodiments of the disclosure, as will be explained in more detail below.

Turning now back to FIG. 8, if the source device 801 is a computer and the image display device 802 is a television, the computer would receive the EDID file structure 810 from the television by sending a request for the EDID file structure 810 over the display data channel 803 at startup. The television will then deliver the EDID file structure 810 to the computer. The computer, upon its processors reading the EDID file structure 810, will configure its output image and sound signals to be optimized for the television's display size and sound output capabilities.

As is quite often the case, the EDID file structure 810 of conventional image display devices 802 is stored in a memory device 811 that is non-volatile. Frequently, this EDID file structure 810 is stored in non-volatile memory when the image display device 802 is being manufactured and is stored as a single format.

Consequently, the EDID file structure 810 can be difficult to change or modify on the fly. What's more, the EDID operating standard wholly fails to provide any mechanism for the image display device 802 to inform the source device 801 regarding the identity of the port to which the cable establishing the display data channel 803 is connected. Thus, in addition to the EDID file structure 810 being fixed in many image display devices, it is simply not possible in the prior art image display device system 800 for the image display device 802 to tell the source device 801 to which port it is connected.

Advantageously, embodiments of the disclosure provide a solution to this problem by utilizing the aforementioned extension flag (401) of the EDID file structure 810 to include an EDID extension that identifies the port to which a source device is connected. Illustrating by example, in one or more embodiments an electronic device operating as an image display device comprises a communication device and one or more processors operable with the communication device. The one or more processors, in response to the communication device identifying an input port establishing a display data channel with a source device, causes the communication device to transmit an EDID extension comprising an identity of the port to which the source device is connected using the display data channel.

In one or more embodiments, the one or more processors alert the source device to the fact that the EDID extension is included by transmitting an EDID file structure having an EDID extension flag set. In one or more embodiments, the communication device identifies the input port using a hot plug detection circuit, one example of which is an HDMI hot plug detection circuit. Thus, regardless of whether the identified port is an HDMI port, a DVI port, or a DisplayPort port, in one or more embodiments the image display device can inform the source device as to exactly which input port the source device is connected.

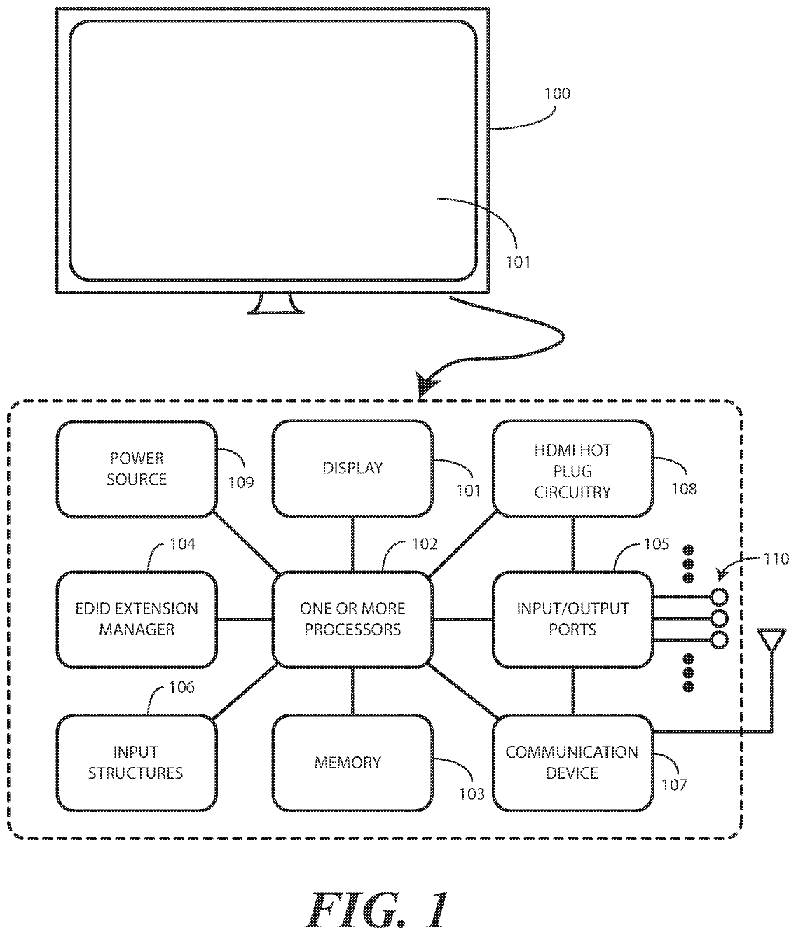

Turning now to FIG. 1, illustrated therein is one explanatory image display device 100 configured in accordance with one or more embodiments of the disclosure. In this illustrative embodiment, the image display device 100 comprises a color video monitor. In other embodiments, the image display device 100 can take other forms. Illustrating by example, the image display device 100 can be a television, a computer display, a laptop display, a tablet computer, or a projector projecting content onto a screen. Other examples of image display devices 100 will be obvious to those of ordinary skill in the art having the benefit of this disclosure.

Regardless of configuration, in one or more embodiments the image display device 100 includes one or more processors 102, a display 101, a memory 103, an audio output that forms one of the various input/output ports 105, and a communication device 107 capable of wired or wireless communication with an electronic device such as the image display device (100) of FIG. 1. In one embodiment, the display 101 is configured as an active-matrix organic light emitting diode (AMOLED) display. However, it should be noted that other types of displays, including liquid crystal displays, would be obvious to those of ordinary skill in the art having the benefit of this disclosure.

In one or more embodiments, the communication device 107 is operable with the various input/output ports 105. In one or more embodiments, the various input/output ports 105 include a plurality of input source connections 110. In one or more embodiments, the communication device 107 is operable with this plurality of input source connections 110 to transmit and receive data with a source device that is coupled to a particular input source connection of the plurality of input source connections 110.

The plurality of input source connections 110 can take a variety of forms. In one or more embodiments, the plurality of input source connections 110 comprises one or more DVI ports. In other embodiments, the plurality of input source connections 110 comprises one or more HDMI ports. In still other embodiments, the plurality of input source connections 110 comprises one or more DisplayPort.sup.™ ports. Of course, other ports, e.g., universal serial bus (USB) ports, optical ports, video graphic array (VGA), and so forth can be included in the plurality of input source connections 110. Moreover, the plurality of input source connections 110 can include multiple types of a single port. Illustrating by example, the plurality of input source connections 110 may include three HDMI ports, two USB ports, a VGA port, and a DVI port for example. Other combinations of ports suitable for inclusion with the plurality of input source connections 110 will be obvious to those of ordinary skill in the art having the benefit of this disclosure.

In one or more embodiments, when coupled by either a wireless or wired connection to a source device, the image display device 100 can function as a primary display for the source device. The source device can, for example, receive content from a terrestrial broadcast network, cable television network, Internet streaming service, or combinations thereof, and redirect this content to the image display device 100 since its display 101 may be larger than the display of the source device (if the source device even has a display). This allows people within the environment of the image display device 100 to more easily see and/or hear the content. In one or more embodiments, content flows from the source device to the image display device 100 through an input source connection of the plurality of input source connections 110 using the communication device 107.

In one or more embodiments, the communication device 107 of the image display device 100 is configured to detect wired electrical communication channels via a hot plug detection feature. Thereafter, in one or more embodiments the one or more processors 102 can cause the communication device 107 to transmit an EDID file structure (810) and corresponding EDID extension identifying the input source connection to which the source device is connected.

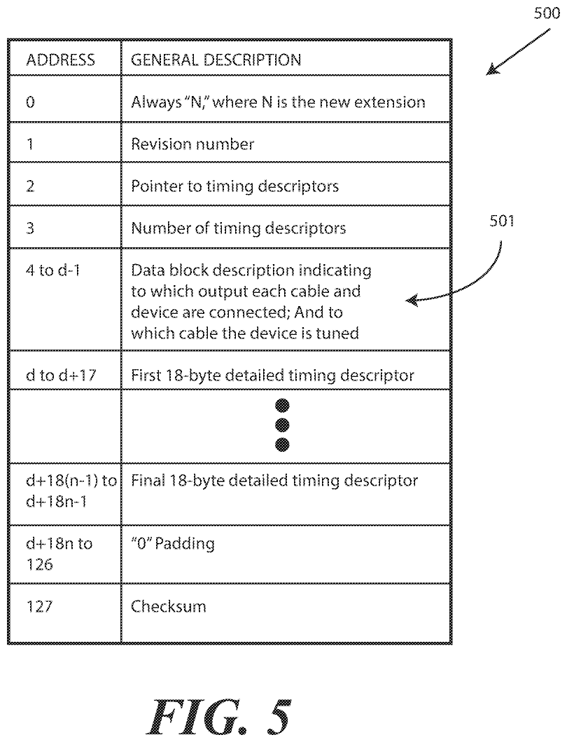

Turning briefly to FIG. 5, illustrated therein is one explanatory EDID extension 500 in accordance with one or more embodiments of the disclosure. As shown, the EDID extension 500 includes a payload field 501 comprising the identity of the input source connection to which a source device is connected. In one or more embodiments, the EDID extension 500 is configured to define advanced capabilities of the image display device (100) of FIG. 1, including identifying a port of the image display device (100) to which a source device establishes a display data channel. Using the payload field 501, one or more processors (102) of the image display device (100) can write the identity of the port to the EDID extension 500 and can cause the communication device (107) of the image display device (100) to transmit the EDID extension 500. In one or more embodiments, the communication device (107) transmits the EDID extension 500 in response to the communication device (107) detecting the establishment of the display data channel. This is in contrast to prior art systems where an EDID file structure (810) will be transmitted in response to source device requests.

The use of an EDID extension 500 to transmit the identity of the port to which a source device is connected advantageously allows legacy devices and new devices alike to identify the connected port. Even image display devices that are not capable of utilizing the second generation of the EDID file structure can still identify the port to which a source device is connected simply by setting the EDID extension flag (401) in the EDID file structure (810) and including the EDID extension 500 with the EDID file structure (810).

However, it should be understood that embodiments of the disclosure are not limited to solely using the EDID extension 500 in an image display device to identify the port to which a source device is connected. In image display devices that do support the second generation of the EDID file structure, rather than using the EDID extension 500, the second generation of the EDID file structure can simply be extended to include the payload field 501 comprising the identity of the input source to which a display data channel has been established as well.

Thus, in other embodiments of the disclosure, one or more processors (102) of an image display device (100), in response to a communication device (107) detecting establishment of a display data channel with a source device, determine to which input source of the plurality of input sources the display data channel is connected. Then, rather than creating and EDID extension 500 comprising the identity of the input source, the one or more processors (102) create a second generation of the EDID file structure comprising an identify of the input source to which the display data channel is connected. The one or more processors (102) then cause the communication device (107) to transmit the second generation of the EDID file structure comprising the identity of the input source using the display data channel.

Turning now back to FIG. 1, in one or more embodiments the image display device 100 can also include input structures 106, nonvolatile storage devices, an expansion card, and a power source 109. The various functional blocks shown in FIG. 1 may include hardware elements (including circuitry), software elements (including computer code stored on a computer-readable medium) or a combination of both hardware and software elements. It should be noted that FIG. 1 is merely one example of a particular implementation and is intended to illustrate the types of components that may be present in the image display device 100. Other circuitry structures for content presentation companion devices configured in accordance with embodiments of the disclosure will be obvious to those of ordinary skill in the art having the benefit of this disclosure.

The one or more processors 102 and/or other data processing circuitry may be operably coupled with the memory 103 and/or the nonvolatile storage (where included). An EDID file structure (810), an EDID extension (500) comprising the identity of an input source to which a source device is connected, a second generation of the EDID file structure comprising the identity of an input source to which a source device is connected, programs or instructions executed by the one or more processors 102, and/or other information can be stored in any suitable article of manufacture that includes one or more tangible, computer-readable media at least collectively storing the instructions or routines. Examples of these elements include the memory 103 and the nonvolatile storage, which can include random-access memory, read-only memory, rewritable flash memory, hard drives, and optical discs.

The input structures 106 can enable a user to interact with the image display device 100. The input/output ports 105 can enable the image display device 100 to interface with various other electronic devices. The expansion cards and/or the communication device 107 can include, for example, content presentation companion device ports to which wired electrical communication channel can be made by coupling a wire or cable, interfaces for a personal area network, such as a Bluetooth network, for a local area networks, such as an 802.11x Wi-Fi network, and/or for a wide area networks, such as a 4G, 5G, 6G, etc., cellular networks. The power source 109 of the image display device 100 may be any suitable source of power, such as a rechargeable lithium polymer (Li-poly) battery and/or an alternating current (AC) power converter. In one or more embodiments, the power source 109 provides a five-volt source voltage to the EDID extension manager 104 so that communication between the EDID extension manager 104 and a source device can be enabled even when the image display device 100 is powered OFF or in a low-power or sleep mode.

The explanatory block diagram schematic shown in FIG. 1 can be configured as a printed circuit board assembly. Various components can be electrically coupled together by electrical conductors, or a bus disposed along one or more printed circuit boards.

The illustrative block diagram schematic of FIG. 1 includes many different components. Embodiments of the disclosure contemplate that the number and arrangement of such components can change depending on the particular use case or application. Accordingly, electronic devices configured in accordance with embodiments of the disclosure can include some components that are not shown in FIG. 1, and other components that are shown may not be needed and can therefore be omitted.

In one embodiment, the one or more processors 102 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the block diagram schematic. Each of the application processor and the auxiliary processor(s) can be configured to process and execute executable software code to perform the various functions of the electronic device with which the block diagram schematic operates. A storage device, such as memory 103, can optionally store the executable software code used by the one or more processors 102 during operation.

In one embodiment, the one or more processors 102 can be responsible for performing the primary functions of the electronic device with which the block diagram schematic is operational. For example, in one embodiment the one or more processors 102 comprise one or more circuits operable with the display 101 to present presentation information to a user. The executable software code used by the one or more processors 102 can be configured as one or more modules that are operable with the one or more processors 102. Such modules can store instructions, control algorithms, and so forth.

Other components operable with the one or more processors 102 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker or other alarms and/or buzzers and/or a mechanical output component such as vibrating or motion-based mechanisms.

An EDID extension manager 104 can be operable with the one or more processors 102 to write the identity of a port to which a source device is connected to an EDID extension (500). In one or more embodiments, EDID extension manager 104 is operable with the one or more processors 102. In some embodiments, the one or more processors 102 can control the EDID extension manager 104. In other embodiments, the EDID extension manager 104 can operate independently, delivering information to the one or more processors 102. The EDID extension manager 104 can receive data from communication device 107, including the identity of an input source connection or port of the one or more input source connections 110 to which a source device is connected. In one or more embodiments, the one or more processors 102 are configured to perform the operations of the EDID extension manager 104.

Working with the other components, the EDID extension manager 104 can cause the communication device 107 to identify a port facilitating an electrical communication channel or display data channel between the image display device 100 and a source device. In one or more embodiments, the communication device 107 identifies this port, input, or input source connection using a HDMI hot plug detection circuit 108.

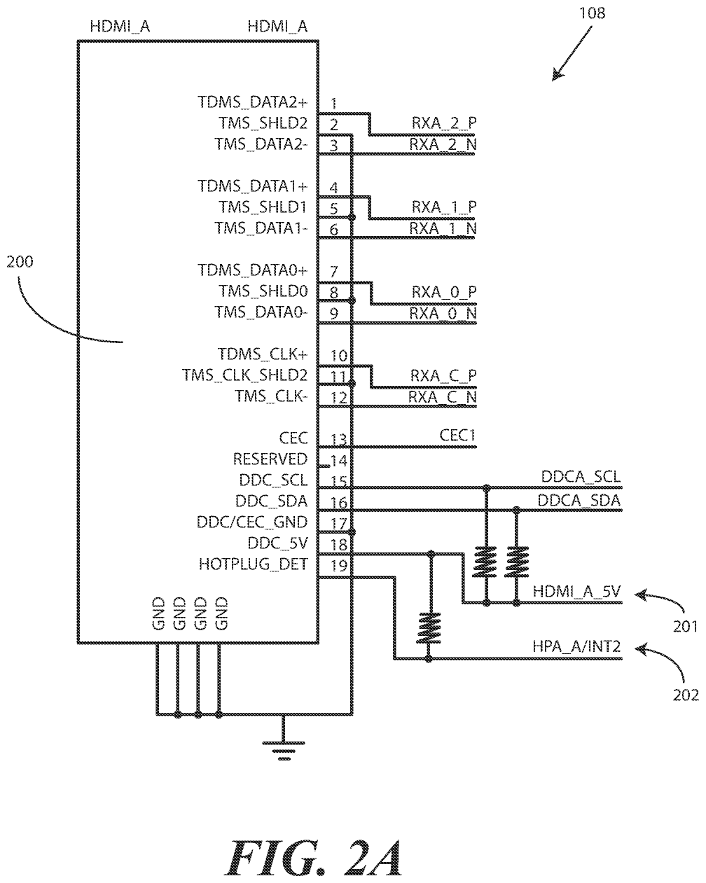

In one or more embodiments, the HDMI hot plug detection circuit 108 uses a hot plug detect feature of the HDMI protocol. In one or more embodiments, the hot plug detect feature relies upon a single pin that is pulled high or low when the image display device 100 is connected to a source device. Using this hot plug detect feature, the image display device 100 can determine to which input source connection of the plurality of input source connections 110 a source device is connected. Turning briefly to FIGS. 2A-2B, illustrated therein is one such HDMI hot plug detection circuit 108.

Beginning with FIG. 2A, an integrated circuit 200 includes a five-volt supply connection 201 and a hot plug detect pin 202. While only one is shown in FIG. 2A, in practice each input source connection of the image display device can include a five-volt supply connection 201 and corresponding interrupt pin input 202. The five-volt supply connection 201 defines an output pin providing a voltage when in an unloaded state.

The hot plug detect pin 202 can be used with interfaces such as DVI interfaces, HDMI interfaces, and DisplayPort.sup.™ interfaces. As shown in FIG. 2B, the five-volt supply connection 201 and a hot plug detect pin 202 are coupled to a transistor array 203 that allows the presence of a voltage on the hot plug detect pin 202 to be detected. When a source device is coupled to the hot plug detect pin 202, it supplies a voltage to the hot plug detect pin 202. An absence of a voltage on the hot plug detect pin 202 means that there is no connection.

The HDMI hot plug detection circuit 108 can thus detect the establishment of the DDC with the source device when a voltage appears at the hot plug detect pin 202. Accordingly, in one or more embodiments the HDMI hot plug detection circuit 108 can advantageously detect which input source connection established a new display data channel due to the fact that a voltage will appear on the hot plug detect pin 202 when that display data channel is established.

Turning now back to FIG. 1, in one or more embodiments the EDID extension manager 104 causes the communication device 107, using the HDMI hot plug detection circuit 108, to query the plurality of input source connections 110 to determine if a physical cable has been coupled to any one input source connection to establish a new display data channel to a source device. The one or more processors 102, in response to the communication device 107 detecting establishment of such a display data channel with the source device, and the EDID extension manager 104 determining to which input source of the plurality of input source connections 110 the display data channel is connected, can then create an EDID extension (500) comprising an identity of the input source connection to which the display data channel is connected. In one or more embodiments, the one or more processors 102 and/or EDID extension manager 104 then cause the communication device 107 to transmit the EDID extension (500) having this identity to the source device using the display data channel.

Where the communication device 107 detects an absence of the voltage at the hot plug detect pin (202), in one or more embodiments the one or more processors 102 record a disconnection event from an input source connection of the plurality of input source connections 110 in the memory 103.

In one or more embodiments, a source device connected to an input source or port of the plurality of input source connections 110 can query the communication device for an EDID file structure (810) and EDID extension (500). Illustrating by example, in one or more embodiments a port querying/identification manager of a source device can query the image display device 100 for the EDID extension (500) identifying the port or input source connection facilitating a wired electrical communication channel between the image display device 100 and the source device using an HDMI protocol. In one or more embodiments. The one or more processors 102 of the image display device 100, in response to receiving such an EDID request, cause the communication device 107 to transmit the EDID file structure (810) and EDID extension (500) to the source device. In one or more embodiments, the one or more processors 102 further, in response to the communication device 107 detecting establishment of the display data channel with the source device, set an EDID extension flag (401) in the EDID file structure (810) to let the source device know that an EDID extension 500 is being transmitted with the EDID file structure (810) as well.

Advantageously, embodiments of the disclosure determine the input port and/or source of an image display device 100 to which a source device is connected with a wire or cable. This allows the source device to present, on a display (or via audio), an identification of the input port and/or source. This allows a user to instantly know how to tune the image display device 100 to have the content from the source device appear on the display 101.

It is to be understood that FIG. 1 is provided for illustrative purposes only and for illustrating components of one image display device 100 in accordance with embodiments of the disclosure and is not intended to be a complete schematic diagram of the various components required for an electronic device operating as an image display device. Therefore, other electronic devices configured in accordance with embodiments of the disclosure may include various other components not shown in FIG. 1 or may include a combination of two or more components or a division of a particular component into two or more separate components, and still be within the scope of the present disclosure.

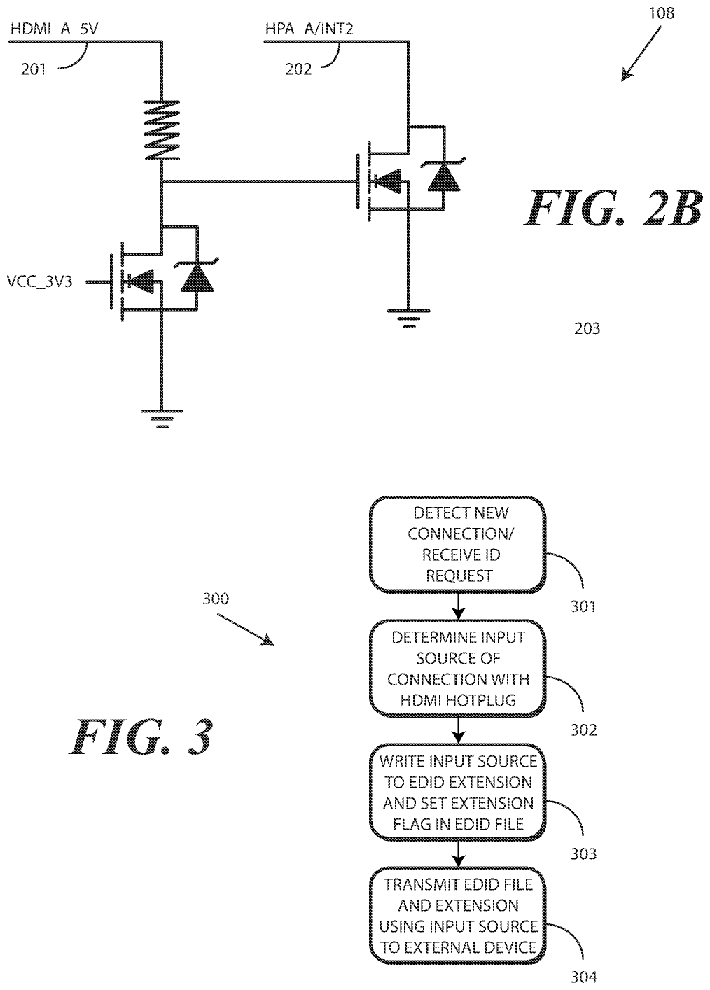

Turning now to FIG. 3, illustrated therein is one explanatory method 300 in accordance with one or more embodiments of the disclosure. The method 300 of FIG. 3 summarizes the functions of identifying a port, input source, or input source connection to which a source device is coupled as described above with reference to FIG. 1. The method 300 is suitable for operation in the image display device (100) of FIG. 1.

Beginning at step 301, the method 300 detects, with a communication device, a source device establishing a display data channel with one port of a plurality of ports of an image display device. This allows for an automatic execution of the method 300 when a display data channel is established between a source device and an image display device. However, in other embodiments step 301 can comprise receiving, with a communication device, an EDID file request. The steps that follow are the same but represent a source device-initiated execution of the method 300 that is an alternative to the automatic execution that occurs in response to establishment of a display data channel.

Step 302 then identifies, with one or more processors, the one port of the plurality of ports establishing the display data channel. In one or more embodiments, this step 302 is preformed using a hot plug detection feature of the HDMI or another similar protocol. Illustrating by example, in one or more embodiments this step 302 comprises detecting, at a hot plug detect pin, a voltage from a source device coupled to the hot plug detect pin. This step 302 can also include detecting the voltage being loaded by the display data channel.

At step 303, the method 300 comprises writing, with one or more processors, the identity of the port establishing the display data channel to an EDID extension. In one or more embodiments, this step 303 also comprises setting, with one or more processors in an EDID file structure, an EDID extension flag.

Step 304 then comprises transmitting, using the communication device, the EDID extension using the display data channel. In one or more embodiments, this step 304 also comprises transmitting the EDID file structure with the EDID extension. Where the method 300 is initiated with establishment of a display data channel, step 304 comprises transmitting the EDID extension using the display data channel in response to the communication device detecting establishment of the display data channel. By contrast, where step 301 comprises receiving an EDID file request, step 304 can comprise the communication device transmitting the EDID file structure and EDID extension in response to the EDID file request, and so forth.

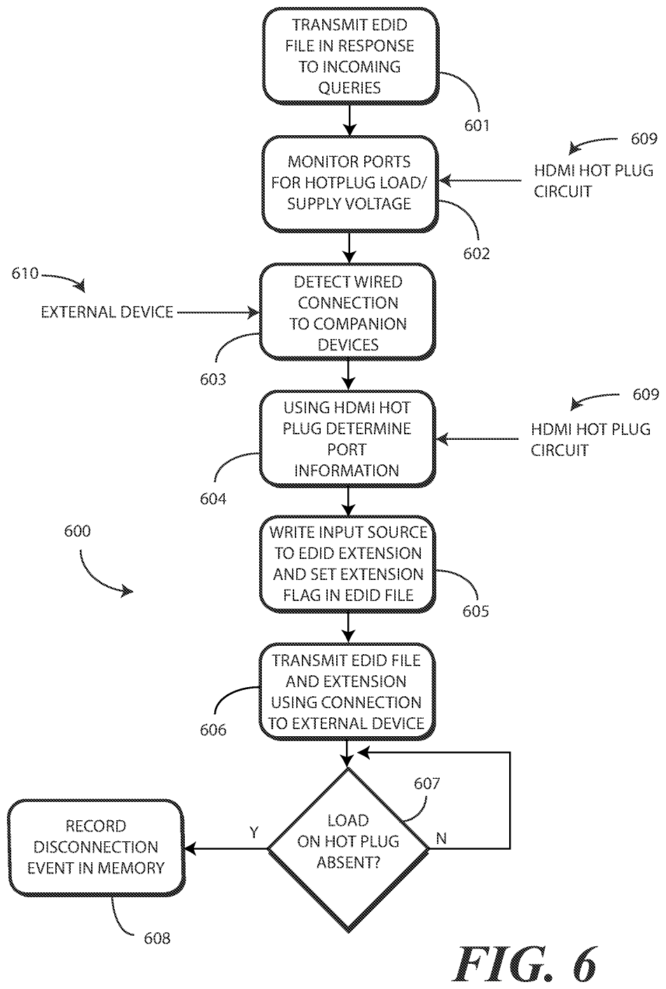

Turning now to FIG. 6, illustrated therein is an alternate method 600 in accordance with one or more embodiments of the disclosure. Beginning at step 601, in one or more embodiments the method 600 transmits an EDID file structure in response to incoming queries. Illustrating by example, where an EDID file request is received, in one or more embodiments step 601 comprises transmitting, with a communication device, an EDID file structure in response to the EDID file request to a remote electronic device making the request.

At step 602, the method 600 monitors one or more ports to identify whether any port establishes a display data channel with a source device. In one or more embodiments, this step 602 comprises using a HDMI hot plug detection circuit 609 as previously described.

Step 603 then detects the establishment of a display data channel by an external device 610 at one of the ports. Step 605 then identifies the port to which the external device 610 is connected. Illustrating by example, when using a HDMI hot plug detection circuit 609, this step 604 can comprise providing an output pin having a voltage when in an unloaded state and detecting the establishment of the display data channel with the external device 610 when a current flows through the output pin of the HDMI hot plug detection circuit 609.

At step 605, the method 600 writes the identification of the port to which the external device 610 is connected to either an EDID extension or a second-generation EDID file structure. As noted above, the use of an EDID extension advantageously allows legacy devices and new devices alike to identify the connected port. Even image display devices that are not capable of utilizing the second generation of the EDID file structure can still identify the port to which the external device 610 is connected simply by setting the EDID extension flag in an EDID file structure and including the EDID extension.

However, in external devices 610 that do support the second generation of the EDID file structure, rather than using the EDID extension, step 605 can comprise extending the second generation of the EDID file structure to include a payload field comprising the identity of the port to which the external device 610 is connected. Accordingly, in one or more embodiments step 605 comprises, in response to detecting establishment of a connection to an external device 610 at step 603, creating a second generation of the EDID file structure comprising an identify of the port to which the external device 610 is connected.

Step 606 then transmits the EDID extension or second generation of the EDID file structure to the external device 610. Decision 607 determines whether there is a disconnection between the external device 610 and the image display device. In one or more embodiments, decision 607 determines whether an absence of current through an output pin of an HDMI hot plug detection circuit exists. Where it does, in one or more embodiments step 608 comprises writing a disconnection event from the external device 610 in a memory device. Otherwise, the method 600 stays in a loop until a disconnection event occurs. Thereafter, the method 600 can repeat when new requests are received at step 601 and/or new connections are detected at step 603.

Advantageously, embodiments of the disclosure determine the input port and/or source to which an external device 610 is connected to an image display device with a wire. In one or more embodiments, after receiving an EDID extension or second-generation EDID file structure, the external device 610 can then present, on a display (or via audio), an identification of the input port and/or source to which it is connected. Other operations can be performed as well. Illustrating by example, in one or more embodiments one or more sensors of the external device 610 can even determine if the image display device is tuned to the input port and/or source. Other advantages will be obvious to those of ordinary skill in the art having the benefit of this disclosure.

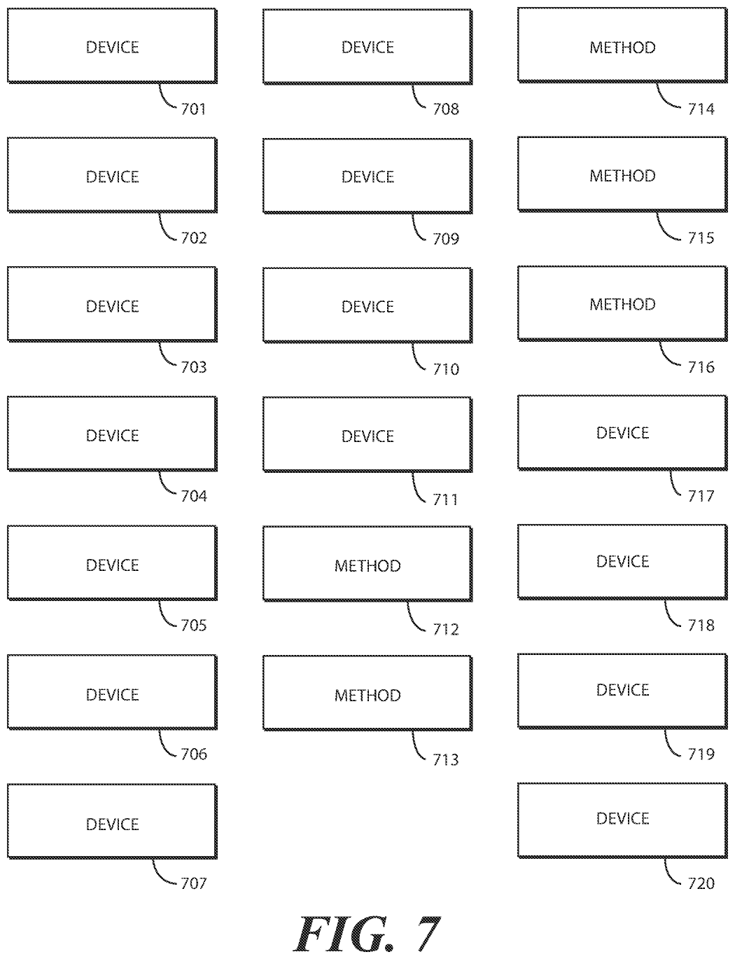

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, an image display device which is connectable to a source device, comprises a plurality of input source connections. At 701, the image display device comprises a communication device operable with the plurality of input source connections and one or more processors operable with the communication device.

At 701, the one or more processors, in response to the communication device detecting establishment of a display data channel with the source device, determine to which input source of the plurality of input sources the display data channel is connected. At 701, the one or more processors create an EDID extension comprising an identity of the input source to which the display data channel is connected. At 701, the one or more processors cause the communication device to transmit the EDID extension to the source device using the display data channel.

At 702, the image display device of 701 further comprises a HDMI hot plug detection circuit operable with the communication device. At 703, the HDMI hot plug detection circuit of 792 comprises an output pin providing a voltage when in an unloaded state and a hot plug detect pin. At 704, the HDMI hot plug detection circuit of 703 detects the establishment of the display data channel with the source device when another voltage appears at the hot plug detect pin.

At 705, the image display device of 704 comprises a memory. At 705, the one or more processors, in response to the communication device detecting an absence of the other voltage at the hot plug detect pin, record a disconnection event from the input source in the memory.

At 706, the input source of 702 comprises a DVI port. At 707, the input source of 702 comprises a HDMI port. At 708, the input source of 702 comprises a DisplayPort port.

At 709, the one or more processors of 701, in response to the communication device receiving an EDID request, cause the communication device to transmit an EDID file to an external electronic device. At 710, the one or more processors of 709 cause the communication device to transmit the EDID extension with the EDID file in response to the EDID request.

At 711, the one or more processors of 701 further, in response to the communication device detecting establishment of the display data channel with the source device, set an EDID extension flag in an EDID file. At 711, the one or more processors cause the communication device to transmit the EDID file comprising the EDID extension flag with the EDID extension.

At 712, a method in an image display device comprises detecting, with a communication device, a source device establishing a display data channel with one port of a plurality of ports of the image display device. At 712, the method comprises identifying, with one or more processors, the one port.

At 712, the method comprises writing, with the one or more processors, the one port to an EDID extension. At 712, the method comprises transmitting the EDID extension using the display data channel in response to the communication device detecting establishment of the display data channel.

At 713, the method of 712 further comprises setting, with the one or more processors in an EDID file, an EDID extension flag. At 713, the method comprises transmitting, with the communication device, the EDID file with the EDID extension using the display data channel.

At 714, the method of 712 further comprises receiving, with the communication device, an EDID file request. At 714, the method comprises transmitting, with the communication device, the EDID file in response to the EDID file request to a remote electronic device.

At 715, the method of 714 further comprises detecting, at a hot plug detect pin of the communication device, a voltage. At 716, the detecting of 715 of the source device establishing the display data channel with the one port of the plurality of ports of the image display device comprises detecting the voltage being loaded by the display data channel.

At 717, an electronic device comprises a communication device and one or more processors operable with the communication device. At 717, the one or more processors, in response to the communication device identifying a port establishing a DDC, cause the communication device to transmit an EDID extension comprising an identity of the port using the display data channel.

At 718, the one or more processors of 717 further cause the communication device to transmit an EDID file comprising an EDID extension flag to using the display data channel. At 719, the communication device of 718 comprises an HDMI hot plug detection circuit. At 720, the port of 719 is one of an HDMI port, a DVI port, or a DisplayPort.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. An image display device which is connectable to a source device, the image display device comprising:
a plurality of input source connections:
a communication device operable with the plurality of input source connections; and
one or more processors operable with the communication device;
the one or more processors, in response to the communication device detecting establishment of a display data channel (DDC) with the source device, determining to which input source of the plurality of input source connections the DDC is connected, creating an extended display identification (EDID) extension comprising an identity of the input source to which the DDC is connected, and causing the communication device to transmit the EDID extension to the source device using the DDC.

2. The image display device of claim 1, further comprising a high-definition multimedia interface (HDMI) hot plug detection circuit operable with the communication device.

3. The image display device of claim 2, the HDMI hot plug detection circuit comprising an output pin providing a voltage when in an unloaded state and a hot plug detect pin.

4. The image display device of claim 3, the HDMI hot plug detection circuit detecting the establishment of the DDC with the source device when another voltage appears at the hot plug detect pin.

5. The image display device of claim 4, further comprising a memory, the one or more processors, in response to the communication device detecting an absence of the another voltage at the hot plug detect pin, recording a disconnection event from the input source in the memory.

6. The image display device of claim 2, the input source comprising a digital visual interface (DVI) port.

7. The image display device of claim 2, the input source comprising a HDMI port.

8. The image display device of claim 2, the input source comprising a DisplayPort port.

9. The image display device of claim 1, the one or more processors, in response to the communication device receiving an EDID request, causing the communication device to transmit an EDID file to an external electronic device.

10. The image display device of claim 9, wherein the one or more processors cause the communication device to transmit the EDID extension with the EDID file in response to the EDID request.

11. The image display device of claim 1, the one or more processors further, in response to the communication device detecting establishment of the DDC with the source device, setting an EDID extension flag in an EDID file and causing the communication device to transmit the EDID file comprising the EDID extension flag with the EDID extension.

12. A method in an image display device, the method comprising:
detecting, with a communication device, a source device establishing a DDC with one port of a plurality of ports of the image display device:
identifying, with one or more processors, the one port:
writing, with the one or more processors, the one port to an EDID extension; and
transmitting the EDID extension using the DDC in response to the communication device detecting establishment of the DDC.

13. The method of claim 12, further comprising:
setting, with the one or more processors in an EDID file, an EDID extension flag; and
transmitting, with the communication device, the EDID file with the EDID extension using the DDC.

14. The method of claim 12, further comprising:
receiving, with the communication device, an EDID file request; and
transmitting, with the communication device, the EDID file in response to the EDID file request to a remote electronic device.

15. The method of claim 14, further comprising detecting, at a hot plug detect pin of the communication device, a voltage.

16. The method of claim 15, wherein the detecting the source device establishing the DDC with the one port of the plurality of ports of the image display device comprises detecting the voltage being loaded by the DDC.

17. An electronic device, comprising:
a communication device; and
one or more processors operable with the communication device;
the one or more processors, in response to the communication device identifying a port establishing a DDC, causing the communication device to transmit an EDID extension comprising an identity of the port using the DDC.

18. The electronic device of claim 17, the one or more processors further causing the communication device to transmit an EDID file comprising an EDID extension flag to using the DDC.

19. The electronic device of claim 18, communication device comprising an HDMI hot plug detection circuit.

20. The electronic device of claim 19, the port one of an HDMI port, a DVI port, or a DisplayPort.
